(19) United States
(12) Patent Application Publication
(10) Pub. No.: US 2021/0099852 A1
(43) Pub. Date: Apr. 1, 2021

(54) REMOTELY-MONITORED PERSONAL SAFETY DEVICES

(71) Applicant: SekureTrak, Inc., Chicago, IL (US)

(72) Inventors: Parminder K. Batra, Chicago, IL (US); Timothy Hansen, St. Charles, IL (US)

(21) Appl. No.: 17/039,617

(22) Filed: Sep. 30, 2020

Related U.S. Application Data
(60) Provisional application No. 62/908,994, filed on Oct. 1, 2019.

(51) Int. Cl. H04W 4/90; H04W 4/029; H04M 1/725

(52) U.S. Cl. CPC H04W 4/90; H04M 1/72538; H04W 4/029

(57) ABSTRACT

Systems and methods for operation and wireless monitoring of personal safety devices are disclosed. A personal safety device comprises processing circuitry, a radio transmitter, a multi-part button, at least one motion-or-position sensing device, a haptic motor, and an indicator light each coupled to the processing circuitry. The processing circuitry periodically broadcasts signals in a wireless beacon format via the radio transmitter including a unique identifier associated with the personal safety and additional information indicating a current state of the personal safety device. A server receives the signals, determines the location of the personal safety device, and provides notifications of the status of the personal safety device to users via a user interface.

### CROSS-REFERENCE TO RELATED APPLICATIONS

This application claims the benefit of priority to U.S. provisional patent application No. 62/908,994, filed Oct. 1, 2019.

### FIELD

The present disclosure relates to systems and methods for tracking individuals using small handheld and other electronic devices and determining that an individual bearing such a device may require assistance.

### BACKGROUND

The following description is provided to assist the understanding of the reader. None of the information provided or references cited is admitted to be prior art. Conventional personal safety devices are small electronic devices which may be carried or worn by a user and are capable of communicating with remote monitoring equipment in order to alert others that the user may require assistance. Some such devices and related systems utilize data collected from accelerometers within the devices to infer that the user has fallen and requires assistance. Some such devices also include a button (e.g., a “panic button”) which the user may press to indicate that they require assistance.

### SUMMARY

In an example embodiment a personal safety device comprises processing circuitry, a radio transmitter, a multi-part button, at least one motion-or-position sensing device, a haptic motor, and an indicator light each coupled to the processing circuitry.

The processing circuitry is configured to periodically broadcast a signal in a wireless beacon format via the radio transmitter. The signal includes a unique identifier associated with the personal safety device in an identifier field specified by the wireless beacon format and additional information in a data field specified by the wireless beacon format indicating a current state of the personal safety device.

The processing circuitry is further configured to determine that the personal safety device has experienced a sudden fall based on data received from the least one motion-or-position sensing device and broadcast the signal with the additional information indicating that the current state of the personal safety device is an alarm state.

The processing circuitry is further configured to determine that the multi-part button has been pressed according to a predetermined sequence, broadcast the signal with the additional information indicating that the current state of the personal safety device is an alarm state, and cause the haptic motor to vibrate according to a predetermined pattern.

The processing circuitry is further configured place the safety button in a low-power state when the signal is not being broadcast.

In another example embodiment, a system for monitoring a personal safety device comprises processing circuitry configured to receive a message from one or more communications devices. The message includes a signal broadcast by a personal safety device according to a wireless beacon format. The signal includes a unique identifier associated with the personal safety device as specified by the wireless beacon format and additional information in a data field specified by the wireless beacon format, the additional information indicating a current state of the personal safety device.

The processing circuitry is further configured to determine a location of the personal safety device based on at least one of: a location included in the information; and a signal strength of the signal broadcast by the personal safety device as received by the one or more communications devices.

The processing circuitry is further configured to provide a notification to a user via a user interface that the current state of the personal safety device indicates at least one of the following: that the personal safety device is operating normally; that a battery of the personal safety device requires charging or replacement; and that the personal safety device has triggered an alarm condition.

When the provided notification indicates that the personal safety device has triggered an alarm condition, the processing circuitry is further configured to receive an instruction from a user via the user interface instructing the processing circuitry to cease providing the notification for a predetermined period of time, and cease providing the notification in response to the instruction until a second message is received including additional information indicating that the personal safety device has triggered a second alarm condition during the predetermined period of time.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is a block-level diagram of an environment in which embodiments disclosed herein may be practiced.

FIG. 2 is a view of an example personal safety device according to embodiments disclosed herein.

FIG. 3 is a pair of views of components forming a personal safety device such as the one shown in FIG. 2 according to embodiments disclosed herein.

FIG. 4 is a series of views of an example enclosure and button cover for the device of FIG. 3.

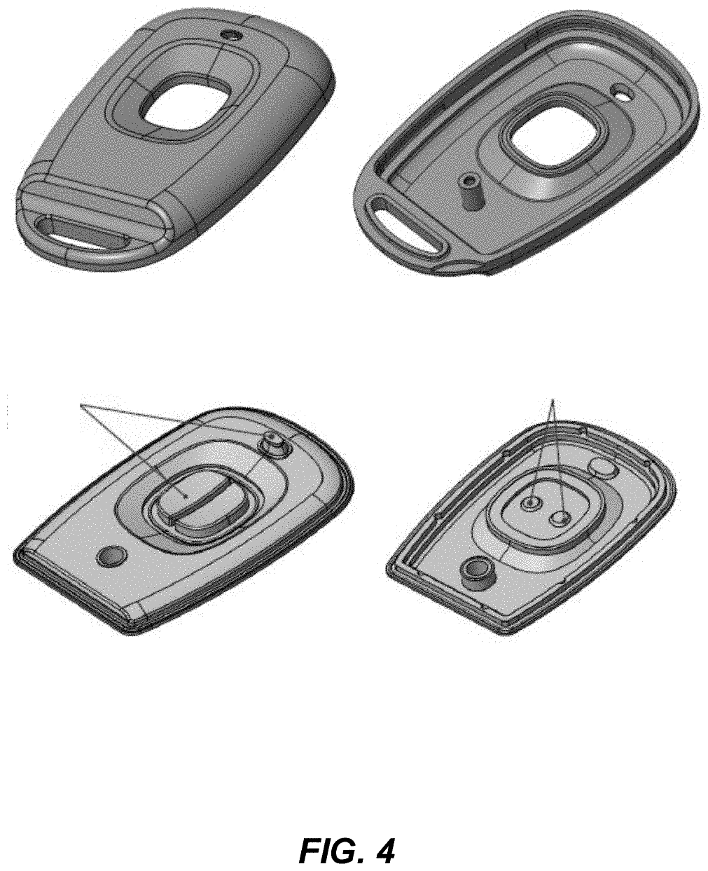

FIG. 5 is a series of views showing the spatial relationship between the device of FIG. 3 and the enclosure of FIG. 4.

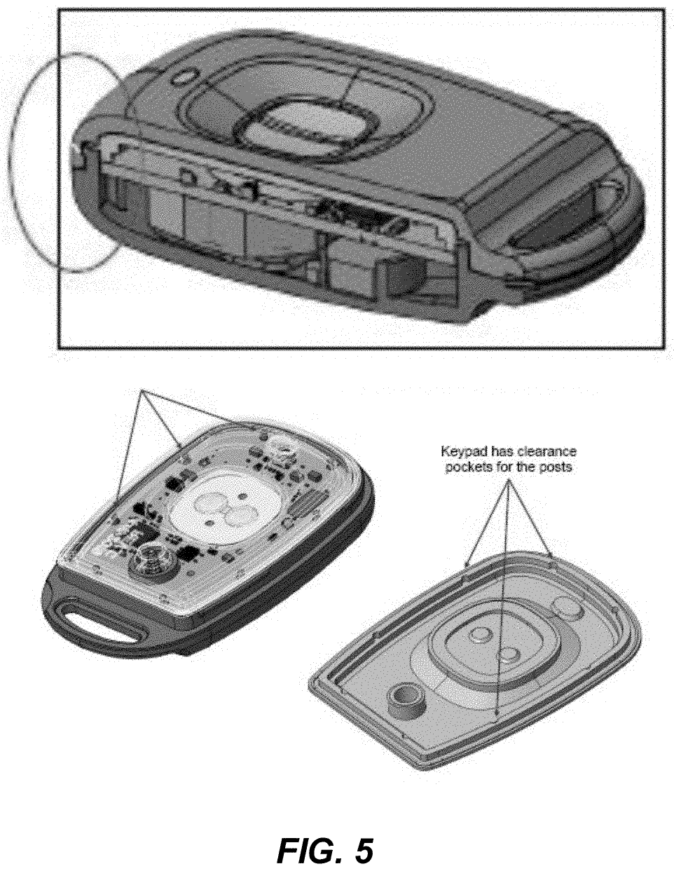

FIG. 6 is a circuit schematic illustrating an arrangement of power-supply elements in certain embodiments of a personal safety device such as the embodiments of FIGS. 2 and 3.

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

Detailed embodiments of the invention are disclosed herein. However, the disclosed embodiments are merely exemplary, and the concepts disclosed herein may be embodied in various and alternative forms. The figures are not necessarily to scale, and some features may be exaggerated or minimized to show details of particular components. Therefore, specific structural and functional details disclosed herein are not to be interpreted as limiting, but merely as representative of the disclosed particular embodiments with the understanding that these may vary according to other illustrative embodiments.

Conventional personal safety devices have limitations. For example, conventional fall detection devices and panic buttons can be prone to false alarms. Such devices may also have insufficient battery life due to constantly transmitting information over long distances.

Systems and methods disclosed herein address these shortcomings by providing personal safety devices which transmit information infrequently and as-needed using low-power wireless beacon protocols. Status information may be transmitted by modifying data in data extended data fields provided by these protocols. Energy storage devices such as a supercapacitor may be employed to reduce peak current loads on batteries within devices disclosed herein to further increase battery life. Multi-part buttons and methods for using such buttons to trigger an alert disclosed herein may be employed to reduce the frequency of false alarms. Haptic and other feedback mechanisms may warn users of impending false alarms, as well as provide confirmation that an alarm has been transmitted when audible notifications might endanger users.

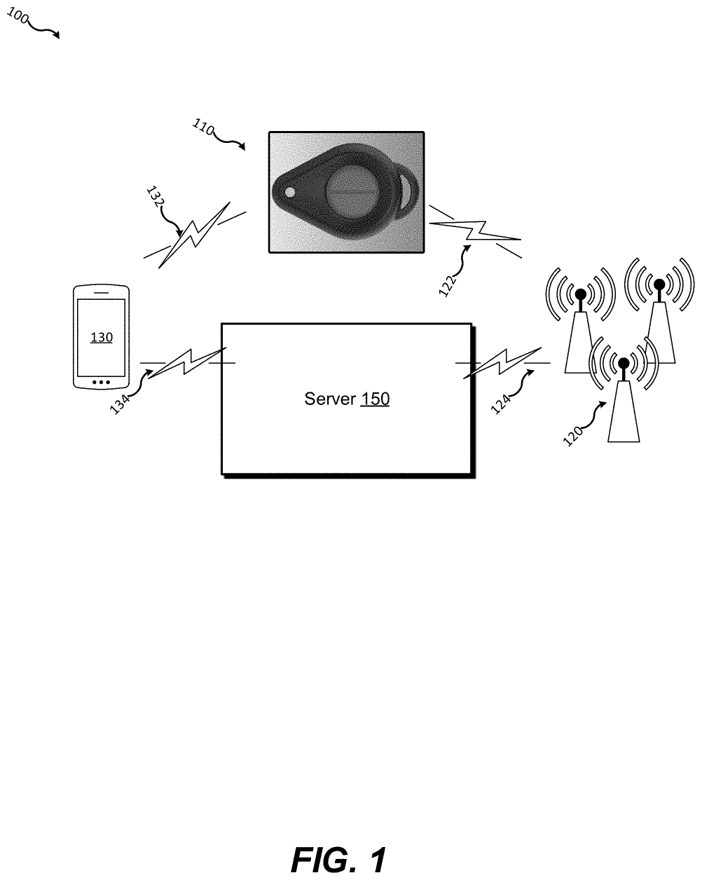

FIG. 1 is a schematic example of an environment 100 in which embodiments disclosed herein may be practiced. An electronic personal safety device (safety button 110) is shown in communication with wireless communication devices 120 via a wireless communications channel 122 and in communication with a mobile computing device (mobile device 130) such as a mobile phone via a communications channel 132. The wireless communication devices 120 communicate with a server 150 via a communications channel 124 and the mobile computing device 130 communicates with the server 150 via a communications channel 134.

The safety button 110 and wireless communications devices 120 may communicate using communication protocols such as WiFi (IEEE 802.11x), Bluetooth, and others. In certain embodiments, the safety button 110 communicates with the wireless communication devices 120 using a low-energy Bluetooth variant (i.e., “Bluetooth LE”). Similarly, the safety button 110 and mobile device 130 may communicate using communication protocols such as WiFi (IEEE 802.11x), Bluetooth, and others. In certain embodiments, the safety button 110 communicates with the mobile device 130 using a low-energy Bluetooth variant (i.e., “Bluetooth LE”). Either or both of the wireless communication devices 120 and the mobile device 130 communicate with a server 150 to relay information concerning the safety button 110. Such information may include the location of the safety button 110 and information concerning the status of the safety button 110 such as whether an alarm condition has been triggered. The location of the safety button 110 may be determined by various means, non-limiting examples of which are disclosed below.

In some embodiments, the safety button 110 is configured to communicate primarily or solely with one or more of the wireless communication devices 130 which may be Bluetooth-enabled WiFi base stations, as a non-limiting example. In some embodiments, the safety button 110 is capable of two-way communication and may receive requests to transmit status information. In other embodiments, the safety button 110 is configured to transmit information only. In some such embodiments the safety button 110 is configured to behave as a Bluetooth “beacon” transmitting information according to a protocol such as the iBeacon protocol developed by Apple Computer, Inc. or the Eddystone protocol developed by Google, Inc., or other such protocols.

In embodiments wherein the safety button 110 communicates primarily or solely with a plurality of wireless communication devices, such as Bluetooth-enabled WiFi base stations and other similar devices, a server such as the server 150 may receive signals from the safety button 110 from such wireless communication devices via a wireless or wired data network. The server 150 may determine the location of the safety button 110 based on measurements of the relative strength of the signals from the safety button 110 as received by individual wireless communications devices 120 whose physical locations are known. In other embodiments in which the safety button 110 communicates primarily or solely with the mobile device 130, the mobile device may use a GPS receiver within the mobile device and/or relative proximity of the mobile device 130 to the wireless communications devices 120 or other devices to determine the location of the mobile device 130 and transmit that location to the server 150 as the location of the safety button 110.

The safety button 110 may trigger an alarm condition when manually activated by an individual, as described further below, or the safety button 110 may automatically trigger an alarm condition when it experiences sudden acceleration and/or deceleration or other changes in position or orientation which indicate that an individual carrying the safety button 110 may have fallen or been injured. The safety button 110 may also be configured to periodically transmit information in the absence of any alarm condition. When the safety button 110 is so configured, the safety button 110 may be further configured to enter a low-power “sleep” state when it is not scheduled to transmit and no alarm condition has been triggered. When the safety button 110 is in a “sleep” state it may be configured to briefly leave the “sleep” state in order to transmit certain information such as a battery level, self-test results, and the like at predetermined intervals such as every 12 hours, every 24 hours, every 48 hours, and so on, as non-limiting examples. In some embodiments, the safety button 110 is configured to transmit an alarm signal once, a small number of times, or repeatedly at predetermined intervals. In other embodiments, the safety button 110 may be configured to repeatedly or continuously generate an alarm signal indefinitely or until canceled by a user, or for a predetermined period of time (e.g., 10 minutes, 20 minutes, 30 minutes, etc.), regardless of any additional actions taken by the user.

The sever 150 may provide a user interface allowing authorized users to view the status of the multiple safety buttons 110 and receive alerts. For example, a user may be able to view the current location of each safety button 110 and whether an alarm condition has been triggered by accessing the server 150 using a web browser or an application running on a mobile device. The server 150 may also be configured to transmit alerts and/or other information concerning safety buttons 110 to various users via e-mail, SMS, push notifications, automated phone calls, or other methods.

In some embodiments, a user receiving or viewing an alarm notification generated by the server 150 for the safety button 110 may provide instructions via the user interface to “silence” an alarm (i.e., suppress continued notifications for a certain time period after the alarm condition has begun). In such embodiments, the sever 150 may be further configured to detect an additional alarm from the safety button 110 and notify the user that a new alarm has been transmitted by the safety button 110 even though the instructions to “silence” the initial alarm are still in effect.

For example, such embodiments may be particularly useful when the safety button 110 is configured as a transmit-only device. Because the safety button 110 cannot determine whether an alarm signal has been received by the server 150, the safety button 110 may be configured to repeatedly transmit an alarm signal for a predetermined time period after an alarm condition has been triggered. Under such conditions, a user receiving notifications from the server 150 may be overwhelmed or distracted by repeated notifications from a single safety button 110 while also tasked with monitoring numerous other safety buttons 110 or performing other tasks, particularly if the user has already determined that the alarm condition is a false alarm or has already responded appropriately (e.g., by sending help to the last know location of the safety button 110). Thus, a user may opt to “silence” alarms from one or more safety buttons 110 for a predetermined time period, or indefinitely. However, it is important in such scenarios that an important alarm is not missed.

For instance, if an individual carrying a safety button 110 triggers a false alarm, but then subsequently falls or is attacked, it may be critical that a user receive additional notifications for that safety button 110 even though the user has explicitly instructed the server 150 to silence alarms for that safety button 110. Thus, the server 150 may continue to monitor signals received from safety button 110 after alarms have been silenced for that safety button 110. Upon detecting that a new alarm has been triggered by a safety button 110 which recently triggered a subsequently-silenced alarm, the server 150 may resume providing notifications of alarm conditions for that safety button 110, overriding the user's previous instruction. The server 150 may provide visual and/or auditory notifications that identify these subsequent alarm notifications as notifications that a new alarm condition has been triggered by the same safety button 110.

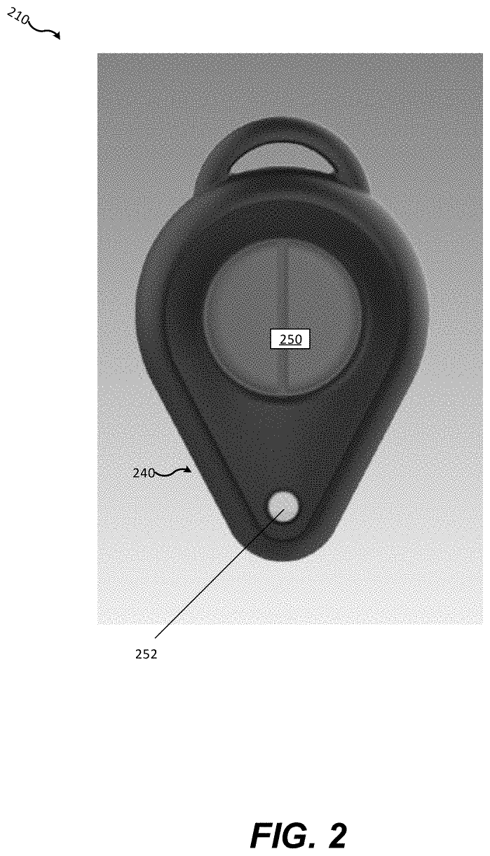

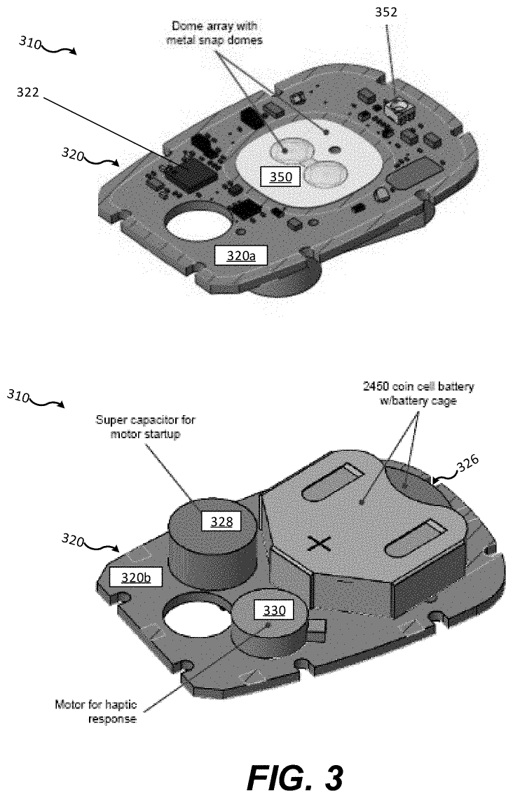

Further details of the safety button 110 will now be described below in connection to FIGS. 2 and 3. FIG. 2 shows an example safety button 210. The safety button 210 includes various components encased in housing 240. The housing may be formed of plastic, metal, or any other suitable material(s). A two-part pushbutton 250 and an indicator 252 are shown. An individual carrying the safety button 210 may depress the pushbutton 250 to trigger an alert condition. The two-part button may allow an individual to trigger different actions or modes of the safety button 210 depending on which of the two segments are depressed, or a sequence of several pushes of either or both of the segments, as will be described further below. The indicator 252 may be a light-emitting device such as a light-emitting diode (LED) or other suitable device and may be used to indicate the status of the safety button 210 under different circumstances by remaining illuminated, remaining unilluminated, blinking continuously, blinking in one or more predetermined patters, etc. Non-limiting examples include indicating that the safety button 210 is in an active state, a low-power (“sleep”) state, in an alarm state, and so on. The safety button 210 is shown with a loop on one end of the housing 240 which may be used to fasten the safety button 210 to a keychain, an article of clothing, or a personal item such as a backpack or purse.

FIG. 3 shows top and bottom views of a printed circuit board 320 forming an example safety button 310 (shown without a housing such as the housing 240). The circuit board 320 has a “top” side 320a and a “bottom” side 320b. The safety button 310 includes a controller 322 as well as other electronic components, such as inductors, capacitors, current drivers, wireless transceivers, and the like. In some embodiments, some such components may be integrated within the controller 322 while some may be discrete components coupled to the controller 322. The controller 322 may contain orientation sensors and/or accelerometers which the controller 322 may use to determine whether an individual carrying the safety button 310 has fallen or been attacked. The controller 322 may also be configured to detect other patterns of motion. A button 350 (shown as a bare actuator) and an indicator 352 are also visible on the top side 320a of the circuit board 320. Additional components visible on the bottom side 320b of the circuit board 320 include a battery 326, a capacitor 328, and a haptic motor 330.

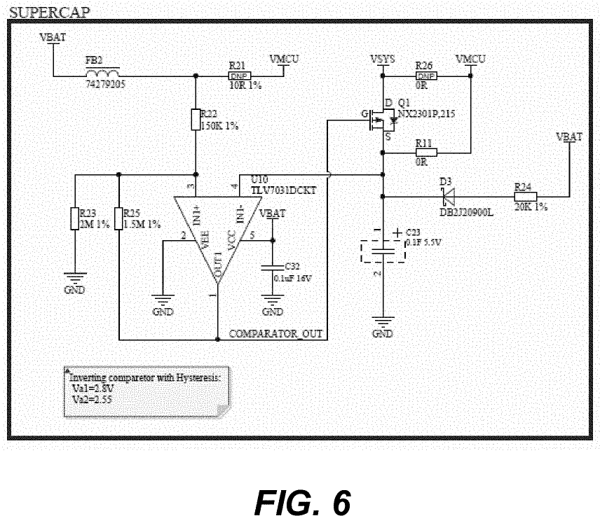

The battery 326 provides power to the controller 322 and other components, including the capacitor 328, which may be a supercapacitor or other similar device. The battery 326 may be used to charge the capacitor 328 and the device may be configured to preferentially draw electrical power from the capacitor 328 during certain periods to prevent the battery 326 from experiencing brief periods of high current load which may shorten the operating life or capacity of the battery 326. The capacitor 328 may be coupled to the battery 326 and other components such as the controller 322 using a switching component to govern its charging and discharging characteristics. In some embodiments (as illustrated by FIG. 6), the capacitor 326 may be charged in at least two ways. First, the positive node of the capacitor may be connected in series to the battery through a Schottky diode and a resistor. Second, the positive node of the capacitor may be attached to the source terminal of a MOSFET-type transistor while the transistor is operating in its cut-off region. The battery 326 and the positive node of the capacitor may both form inputs to a comparator the output of which is connected to the gate terminal of the same MOSFET.

Once the capacitor 328 is charged, the MOSFET transistor transitions from operating in the cut-off region to operating in the saturation region, thereby switches the direction of the current and allowing for power to be supplied to the rest of the system and the controller 322. This power is regulated by the frequency of switching and a current regulating circuit between the capacitor's positive terminal and the voltage supplied to the controller 322, ensuring that the controller 322 is not being overpowered.

The safety button 310 may be enclosed within an enclosure similar to the enclosure 240 pictured in FIG. 2 and the button 350 may be coupled to a button cover or pad similarly to the button 250 shown in FIG. 2 causing the controller 322 to register when the button 350 is pressed Analogously to the two-part button 250, the button 350 shown in FIG. 3 uses a two-part actuator, allowing the controller to register whether one or both parts of the button have been pressed.

The controller 322 is configured to wirelessly broadcast signals to other devices such as the wireless communication devices 120 or the mobile device 130 shown in FIG. 1. In some embodiments, the safety button 310 is configured to communicate primarily or solely with an associated mobile device such as the mobile device 130. In such embodiments, the mobile device may determine its location and transmit that location, along with information received from the safety button 310 over a network to a server such as the server 150 of FIG. 1.

In embodiments wherein the safety button 310 is configured to behave as an iBeacon, the safety button 310 transmits a universally unique identifier (UUID) according to the iBeacon protocol. The safety button 310 may also transmit a major value, and a minor value, each of which are 16-bits in length, as defined by the iBeacon protocol. Unlike conventional iBeacon devices, the safety button 310 may use the major and/or minor value to transmit different information at different times such as information concerning the state of the safety button 310. For example, the safety button 310 may transmit one set of values to report a normal status, another set of values to report a low-battery condition, another set of values to report an alarm triggered by pressing the button 350, another set of values to report an automatically-generated alarm condition (based on position and/or acceleration data, for example), and so on. As a further example, if the safety button 310 is transmitting a set of values indicating that the alarm condition has been triggered previously, the safety button 310 may transmit a new set of values indicating that a new alarm condition has been triggered.

The two-part button configuration shown for buttons 250 and 350 may be used to reduce the likelihood of false alarms due to errant button presses. For example, controller 322 of the safety button 310 may be configured to generate an alarm only if both portions of the button 350 are depressed simultaneously or within a predetermined time interval. In another example, the controller 322 may be configured to generate an alarm only if a particular sequence of button presses is detected. In yet another example, the controller 322 may be configured to generate different alarms or other signals for each of a plurality of recognized sequences of button presses. The controller 322 may also be configured to pair with an external device to receive firmware updates or may be configured to change various operating parameters in response to various predefined sequences of presses of the button 350.

The controller 322 may use the haptic motor 330 to provide haptic feedback to a user of the safety button 310. For example, the controller 322 may activate the haptic motor 330 to cause the safety button 310 to vibrate silently to inform a user that an alarm has been generated, or to inform the user that the battery 328 is in need of replacement. As above, the indicator 352 may also be used to provide similar feedback.

One or more operations described herein may be carried out by processing circuitry which can execute instructions as known to those skilled in the art. The instructions may be carried out by one or more special purpose computers, logic circuits (e.g., programmable logic circuits (PLC)), and/or hardware circuits. Thus, wireless communication devices 120, the mobile device 130, the server 150, and the controller 322, for example, may be implemented in hardware, firmware, software, or any combination of these methods. The term “execution” is the process of running an application or the carrying out of the operation called for by an instruction. The instructions may be written using one or more programming languages, scripting languages, assembly languages, etc. The wireless communication devices 120, the mobile device 130, the server 150, and the controller 322, or other devices described herein may execute an instruction, meaning that they perform the operations called for by that instruction The wireless communication devices 120, the mobile device 130, the server 150, and the controller 322 may retrieve instructions from a permanent memory device, such as a read-only memory (ROM) device, and copy the instructions in an executable form to a temporary memory device that is generally some form of random access memory (RAM). The server 150 or other computing devices described herein may include a plurality of processors that use the same or a different processing technology.

The operations described in this specification can be implemented as operations performed by a data processing apparatus on data stored on one or more computer-readable storage devices or received from other sources. The terms “data processing apparatus” or “computing device,” “mobile device,” “server,” and related terms encompass all kinds of apparatus, devices, and machines for processing data, including, by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures. Data processing apparatus may be physical or may be virtualized data processing apparatus running in a virtual machine. Data processing apparatus may also be formed within distributed (“cloud”) computing systems.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media, and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user, and a keyboard and/or an I/O device, e.g., a mouse or a touch sensitive screen, by which the user can provide input to the computer. Other kinds of devices can be used to provide for interaction with a user as well; for example, feedback provided to the user can be any form of sensory feedback, e.g., visual feedback, auditory feedback, and/or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. In some cases, the actions recited herein can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A personal safety device comprising:
processing circuitry, a radio transmitter, a multi-part button, at least one motion-or-position sensing device, a haptic motor, and an indicator light each coupled to the processing circuitry, the processing circuitry configured to:
periodically broadcast a signal in a wireless beacon format via the radio transmitter, the signal including a unique identifier associated with the personal safety device in an identifier field specified by the wireless beacon format and additional information in a data field specified by the wireless beacon format indicating a current state of the personal safety device;
determine that the personal safety device has experienced a sudden fall based on data received from the least one motion-or-position sensing device and broadcast the signal with the additional information indicating that the current state of the personal safety device is an alarm state; and
place the safety button in a low-power state when the signal is not being broadcast.

2. The personal safety device of claim 1, further comprising a battery electrically coupled to a supercapacitor, wherein the processing circuitry includes a controller and wherein the supercapacitor is electrically coupled to the controller.

3. The personal safety device of claim 2, wherein the controller preferentially draws power from the supercapacitor.

4. The personal safety device of claim 1, the device configured to communicate with a wireless communication device using a low-energy Bluetooth variant.

5. The personal safety device of claim 1, the device configured to communicate with a wireless communication device using a WiFi protocol.

6. The personal safety device of claim 1, wherein the processing circuitry further is configured to determine that the multi-part button has been pressed and broadcast the signal with the additional information indicating that the current state of the personal safety device is an alarm state.

7. The personal safety device of claim 6, wherein, in response to the multi-part button having been pressed, the processing circuitry further is configured to cause the haptic motor to vibrate according to a predetermined pattern.

8. The personal safety device of claim 6, wherein the processing circuitry further is configured to broadcast the signal with different additional information in response to the multi-part button having been pressed according to a different predetermined sequence.

9. A personal safety device comprising:
processing circuitry, a radio transmitter, a multi-part button, at least one motion-or-position sensing device, a haptic motor, and an indicator light each coupled to the processing circuitry, the processing circuitry configured to:
periodically broadcast a signal in a wireless beacon format via the radio transmitter, the signal including a unique identifier associated with the personal safety device in an identifier field specified by the wireless beacon format and additional information in a data field specified by the wireless beacon format indicating a current state of the personal safety device;
determine that the personal safety device has experienced a sudden fall based on data received from the least one motion-or-position sensing device and broadcast the signal with the additional information indicating that the current state of the personal safety device is an alarm state;
determine that the multi-part button has been pressed according to a predetermined sequence, broadcast the signal with the additional information indicating that the current state of the personal safety device is an alarm state, and cause the haptic motor to vibrate according to a predetermined pattern; and
place the safety button in a low-power state when the signal is not being broadcast.

10. The personal safety device of claim 9, further comprising a battery electrically coupled to a supercapacitor, wherein the processing circuitry includes a controller and wherein the supercapacitor is electrically coupled to the controller.

11. The personal safety device of claim 10, wherein the controller preferentially draws power from the supercapacitor.

12. The personal safety device of claim 9, the device configured to communicate with a wireless communication device using a low-energy Bluetooth variant.

13. The personal safety device of claim 9, the device configured to communicate with a wireless communication device using a WiFi protocol.

14. A system for monitoring a personal safety device comprising processing circuitry configured to:
receive a message from one or more communications devices, the message including a signal broadcast by a personal safety device according to a wireless beacon format, the signal including a unique identifier associated with the personal safety device as specified by the wireless beacon format and additional information in a data field specified by the wireless beacon format, the additional information indicating a current state of the personal safety device;
determine a location of the personal safety device based on at least one of:
a location included in the information; and
a signal strength of the signal broadcast by the personal safety device as received by the one or more communications devices
provide a notification to a user via a user interface that the current state of the personal safety device indicates at least one of the following:
that the personal safety device is operating normally;
that a battery of the personal safety device requires charging or replacement; and
that the personal safety device has triggered an alarm condition;
wherein, when the provided notification indicates that the personal safety device has triggered an alarm condition, the processing circuitry is further configured to:
receive an instruction from a user via the user interface instructing the processing circuitry to cease providing the notification for a predetermined period of time; and
cease providing the notification in response to the instruction until a second message is received including additional information indicating that the personal safety device has triggered a second alarm condition during the predetermined period of time.

15. The system of claim 14, further comprising a battery electrically coupled to a supercapacitor, wherein the processing circuitry includes a controller and wherein the supercapacitor is electrically coupled to the controller.

16. The system of claim 14, wherein the controller preferentially draws power from the supercapacitor.

17. The system of claim 14, the device configured to communicate with a wireless communication device using a low-energy Bluetooth variant.

18. The system of claim 14, the device configured to communicate with a wireless communication device using a WiFi protocol.
